(19) United States
(12) Patent Application Publication
(10) Pub. No.: US 2009/0047619 A1
(43) Pub. Date: Feb. 19, 2009

(54) Cordless Complex Root Canal Plugger for Dental Clinic

(76) Inventors: Suk-song Oh, Cheongju-city (KR); Hae-joong Kim, Cheongju-city (KR); Chang-jin Ji, Cheongju-city (KR); Do-yeon Kim, Chungju-city (KR); Young-muk Choi, Chungju-city (KR); Sung-joon Choi, Cheongju-city (KR); Sung-min Ha, Seoul-city (KR)

Correspondence Address: GREER, BURNS & CRAIN, 300 S WACKER DR, 25TH FLOOR, CHICAGO, IL, 60606, US

(21) Appl. No.: 11/883,705

(22) PCT Filed: Feb. 2, 2006
(86) PCT No.: PCT/KR06/00363

§ 371 Date: May 12, 2008

(30) Foreign Application Priority Data
Feb. 4, 2005 (KR) 10-2005-0010361

(51) Int. Cl. A61C 3/08

(52) U.S. Cl. 433/32

(57) ABSTRACT

A cordless complex root canal plugger for dental clinics is disclosed. The root canal plugger includes a battery charger; a pen-type vertical spreader having a rechargeable battery unit and a control unit therein; and a gun-type injection device having both a rechargeable battery unit and a control unit therein. The battery charger, the pen-type vertical spreader and the gun-type injection device are provided as a group of complementary products. The cordless complex root canal plugger allows an endodontist to move freely in a dental clinic while executing a root canal plugging procedure using the cordless complex root canal plugger during nerve treatment. Thus, the endodontist can more easily, rapidly and precisely pack a root canal with a filler material and, therefore, the cordless complex root canal plugger induces en-dodontists to buy it.

### TECHNICAL FIELD

The present invention relates, in general, to complex root canal pluggers for dental clinics and, more particularly, to a cordless complex root canal plugger for dental clinics including a battery charger, a pen-type vertical spreader and a gun-type injection device, which are provided as a group of complementary products and in which the pen-type vertical spreader and the gun-type injection device have respective rechargeable batteries and respective controllers, and can be seated on the battery charger when they are required to be electrically charged or when they are not being used, so that the cordless complex root canal plugger allows an endodontist to move freely in a dental clinic while executing a root canal plugging procedure using the cordless complex root canal plugger during nerve treatment and, therefore, the endodontist can more easily, rapidly and precisely pack a root canal with a filler material and, therefore, the cordless complex root canal plugger induces endodontists to buy it.

### BACKGROUND ART

Generally, during dental treatment of a decayed tooth in a dental clinic, an endodontist appropriately removes decayed parts from the tooth using dental drilling and reaming implements and performs a root canal plugging procedure for packing a root canal with a filler material, prior to covering the packed tooth using a crown. Such dental treatment for decayed teeth is known as root canal treatment, which is a very complex and very difficult treatment. During the root canal treatment, the root canal plugging is the last process of the treatment and determines the success or failure of the root canal treatment. The root canal plugging has been typically executed by packing a plurality of gutta-percha cones into a root canal, however, this conventional root canal plugging using the plurality of gutta-percha cones is problematic in that the root canal plugging consumes excessive time and may undesirably break a tooth root while an endodontist forcibly packs the filler material laterally into the tooth root using a spreader or the like.

In an effort to solve the problems, a variety of methods, configured to efficiently and quickly plug root canals with a filler material using dental implements, has been proposed. Among the conventional plugging methods, vertical compaction methods using pen-type spreaders and injection methods using gun-type injection devices have become known as the most effective methods executed in dental clinics.

FIG. 11 is a view illustrating a conventional complex root canal plugger for dental clinics. As shown in FIG. 11, the conventional complex root canal plugger 10 for dental clinics includes a controller 12, a pen-type vertical spreader 14 and a gun-type injection device 16, both being connected to the controller 12 through respective electric cords. A battery is installed in the controller 12. The battery is preferably selected from nickel-hydrogen batteries having a current capacity of 8,000 mA, a protective circuit, which comprises a bimetal S/W and a poly S/W, and a voltage of 3.6V.

However, the conventional complex root canal plugger 10 for dental clinics is problematic as follows due to the complex construction thereof. Described in detail, both the pen-type vertical spreader 14 and the gun-type injection device 16 are connected to the single controller 12 through respective electric cords, so that the plugger 10 cannot be conveniently used in dental clinics. Furthermore, because an AC/DC converter is connected to the controller 12, it is not easy to move the root canal plugger 10 in a dental clinic. The electric cords of both the pen-type vertical spreader 14 and the gun-type injection device 16 may become entangled with each other, or may become entangled with the electric cords of other dental implements, so that the dental clinic may become disordered due to the entanglement of the electric cords and, therefore, patients may feel dissatisfied or uncomfortable and the dental treatment schedule may be delayed.

### DISCLOSURE OF INVENTION

### Technical Problem

Accordingly, the present invention has been made keeping in mind the above problems occurring in the prior art, and an object of the present invention is to provide a cordless complex root canal plugger for dental clinics, which includes a battery charger, a pen-type vertical spreader and a gun-type injection device provided as a group of complementary products, and in which the pen-type vertical spreader and the gun-type injection device have respective rechargeable batteries and respective controllers, and can be seated on the battery charger when they are required to be electrically charged or when they are not being used, so that the cordless complex root canal plugger allows an endodontist to move freely in a dental clinic while executing a root canal plugging procedure using the cordless complex root canal plugger during nerve treatment and, therefore, the endodontist can more easily, rapidly and precisely pack a root canal with a filler material and, therefore, the cordless complex root canal plugger induces endodontists to buy it.

### Technical Solution

In order to achieve the above object, according to one aspect of the present invention, there is provided a cordless complex root canal plugger for dental clinics, comprising:

a battery charger comprising: a lower casing provided with both a first charging terminal and a second charging terminal therein; and an upper casing, which covers the lower casing and is provided with a first charging seat and a second charging seat, through which the first charging terminal and the second charging terminal of the lower casing are exposed outside the battery charger, respectively;

a pen-type vertical spreader comprising: a pen-shaped body part; a first rechargeable battery unit detachably attached to the pen-shaped body part and brought into contact with the first charging terminal to be charged with electricity; a first control unit placed in the pen-shaped body part and electrically connected to the first rechargeable battery unit; and a chucking unit, which locks a plugger tip to an end of the pen-shaped body part and is electrically connected to the first control unit, thus generating heat due to resistance and thermally softening a gutta-percha cone packed into a root canal, wherein the pen-type vertical spreader is seated in the first charging seat of the battery charger when the pen-type vertical spreader is required to be charged with electricity or when the spreader is not being used; and

a gun-type injection device comprising: a gun-shaped body part having a shape similar to the shape of a conventional gun; an actuation unit provided in the gun-shaped body part; a second rechargeable battery unit detachably attached to the gun-shaped body part and brought into contact with the second charging terminal to be charged with electricity; a second control unit provided in the gun-shaped body part and electrically connected to the second rechargeable battery unit; and a heating and discharging unit electrically connected to the second control unit, thus thermally softening and discharging a gutta-percha bar, which has been input into the actuation unit through the gun-shaped body part, wherein the gun-type injection device is seated in the second charging seat of the battery charger when the gun-type injection device is required to be charged with electricity or when the injection device is not being used, wherein the battery charger, the pen-type vertical spreader and the gun-type injection device are provided as a group of complementary products.

As is apparent from the above descriptions, according to the present invention, the cordless complex root canal plugger for dental clinics includes a battery charger, a pen-type vertical spreader and a gun-type injection device, which are provided as a group of complementary products and in which the pen-type vertical spreader and the gun-type injection device have respective rechargeable batteries and respective controllers, and can be seated on the battery charger when they are required to be electrically charged or when they are not being used. Thus, the cordless complex root canal plugger allows an endodontist to move freely in a dental clinic while executing a root canal plugging procedure using the cordless complex root canal plugger during nerve treatment. The endodontist can more easily, rapidly and precisely pack a root canal with a filler material using the cordless complex root canal plugger and, therefore, the cordless complex root canal plugger induces endodontists to buy it.

### BRIEF DESCRIPTION OF THE DRAWINGS

FIG. 1 is a perspective view illustrating a cordless complex root canal plugger for dental clinics according to the present invention;

FIG. 2 is a perspective view illustrating a battery charger shown in FIG. 1;

FIG. 3 is a perspective view illustrating the interior of the battery charger of FIG. 2;

FIG. 4 is a perspective view illustrating a pen-type vertical spreader shown in FIG. 1;

FIG. 5 is a sectional view taken along line A-A of FIG. 4;

FIG. 6 is a perspective view illustrating the interior of the pen-type vertical spreader of FIG. 4;

FIG. 7 is a front view illustrating a gun-type injection device shown in FIG. 1;

FIG. 8 is a plane view illustrating the gun-type injection device shown in FIG. 1;

FIG. 9 is a sectional view taken along line B-B of FIG. 8;

FIG. 10 is a perspective view illustrating the interior of the gun-type injection device of FIG. 7; and

FIG. 11 is a view illustrating a conventional complex root canal plugger for dental clinics.

### BEST MODE FOR CARRYING OUT THE INVENTION

Hereafter, a cordless complex root canal plugger for dental clinics according to the preferred embodiment of the present invention will be described with reference to the accompanying drawings.

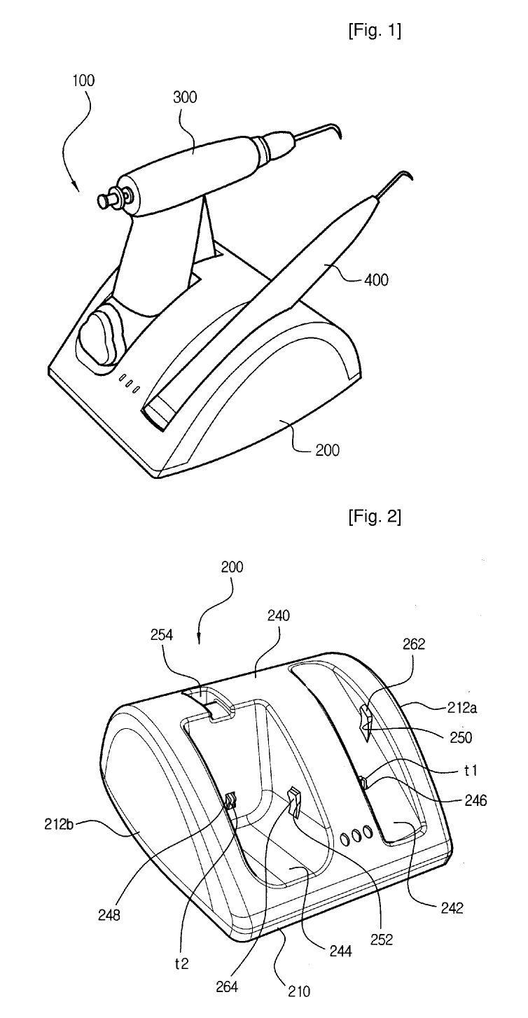

FIG. 1 is a perspective view illustrating a cordless complex root canal plugger for dental clinics according to the present invention.

As shown in FIG. 1, the cordless complex root canal plugger 100 for dental clinics according to the present invention comprises a battery charger 200, a pen-type vertical spreader 300 and a gun-type injection device 400, in which the pen-type vertical spreader 300 and the gun-type injection device 400 can be seated on and electrically charged by the battery charger 200 when they are required to be electrically charged or when they are not being used.

FIG. 2 is a perspective view illustrating the battery charger shown in FIG. 1. FIG. 3 is a perspective view illustrating the interior of the battery charger of FIG. 2.

As shown in FIGS. 2 and 3, the battery charger 200 comprises a lower casing 210 and an upper casing 240. The lower casing 210 includes both a first charging terminal t1 and a second charging terminal t2 therein. The upper casing 240 covers the top of the lower casing 210 and includes a first charging seat 242 and a second charging seat 244, through which, respectively, the first charging terminal t1 and the second charging terminal t2 of the lower casing 210 are exposed outside the battery charger 200.

The lower casing 210 has a flat bottom plate, so that the casing 210 can be stably placed on a support surface, with a first side plate 212a and a second side plate 212b integrally formed at opposite ends of the flat bottom plate such that the two plates 212a and 212b face each other. Preferably, each of the first side plate 212a and the second side plate 212b is specifically curved along the upper edge thereof such that the radius of curvature of a first side of the curved upper edge of each side plate 212a or 212b is longer than that of a second side of the upper edge. A power converter unit 220 is vertically placed between the second sides of the curved upper edges of the two side plates 212a and 212b of the lower casing 210. The power converting unit 220 converts AC electricity supplied from a power source outside the lower casing 210 into DC electricity. A charging unit 230 is horizontally placed at a position around the power converter unit 220. In the above state, the charging unit 230 is provided with both the first charging terminal t1 at a position adjacent to the first side plate 212a and the second charging terminal t2 at a position adjacent to the second side plate 212b. Each of the first and second charging terminals t1 and t2 can be selected from conventional charging terminals. A first locking hook 232 having a U-shape is placed at a position adjacent to the second end of the first charging terminal t1. In the same manner, a second locking hook 234 having a U-shape is placed at a position adjacent to the second end of the second charging terminal t2.

The upper casing 240 covers the top of the lower casing 210, so that both the power converter unit 220 and the charging unit 230 are embedded in the battery charger 200 while being placed on the lower casing 210. The upper casing 240 has a specifically curved shape so as to correspond to the curved shape of the upper edges of both the first and second side plates 212a and 212b. The radius of curvature of a first surface of the specifically curved upper casing 240 is longer than that of a second surface of the curved upper casing 240. Both the first charging seat 242 and the second charging seat 244 are formed in the first surface of the curved upper casing 240, which has the longer radius of curvature. The first charging seat 242 is formed in the first surface of the upper casing 240 at a position adjacent to the first side plate 212a such that the first charging seat 242 extends from a first end to a second end of the gently curved first surface of the upper casing 240 while the bottom surface of the first charging seat 242 is curved downwards. The second charging seat 244 is formed in the first surface of the upper casing 240 at a position adjacent to the second side plate 212b such that the second charging seat 244 is vertically depressed downwards. In the first charging seat 242, a first terminal hole 246 is formed in the bottom surface of the first charging seat 242, thus exposing the first charging terminal t1 outside the first charging seat 242. In the same manner, in the second charging seat 244, a second terminal hole 248 is formed in a rear surface of the second charging seat 244, thus exposing the second charging terminal t2 outside the second charging seat 244. Furthermore, in the first charging seat 242, a pair of first exposure holes 250 is formed to expose the opposite upper ends of the U-shaped first locking hook 232 outside opposite side surfaces of the first charging seat 242. In the same manner, in the second charging seat 244, a pair of second exposure holes 252 is formed to expose the opposite upper ends of the U-shaped second locking hook 234 outside opposite side surfaces of the second charging seat 244. A third charging seat 254, having a width smaller than that of the second charging seat 244, is formed in the upper casing 240 by being depressed downwards at a position adjacent to the rear surface of the second charging seat 244.

Preferably, the charging unit 230 comprises a first display lamp 256 and a second display lamp 258, which display the charged state of both the pen-type vertical spreader 300 and the gun-type injection device 400 respectively seated in and electrically charged by the first charging seat 242 and the second charging seat 244. A power lamp 260 is placed between the first display lamp 256 and the second display lamp 258 and informs an endodontist of the on/off state of the battery charger 200. The three lamps 256, 258 and 260 are exposed outside the upper casing 240 at positions between the first charging seat 242 and the second charging seat 244. Furthermore, first grip pads 262 and second grip pads 264, which are made of rubber, are preferably attached to the opposite upper ends of each of the first locking hook 232 and the second locking hook 234 such that the grip pads 262 or 264 face each other. At least one of the pen-type vertical spreader 300 and the gun-type injection device 400 may be seated on the battery charger 200 when they are required to be electrically charged or when they are not being used.

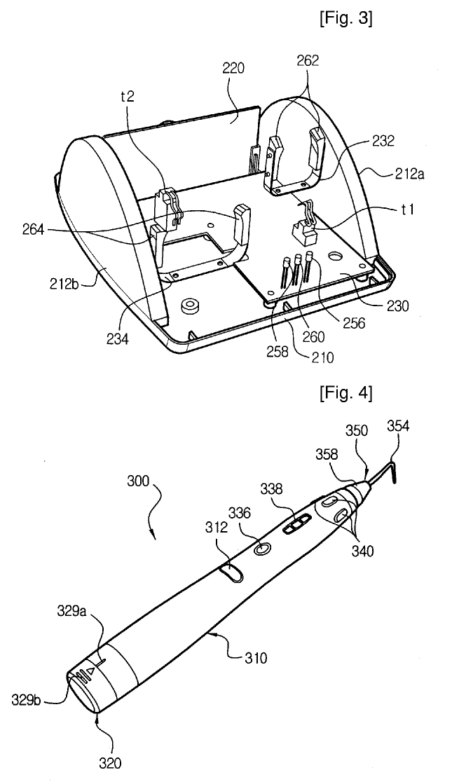

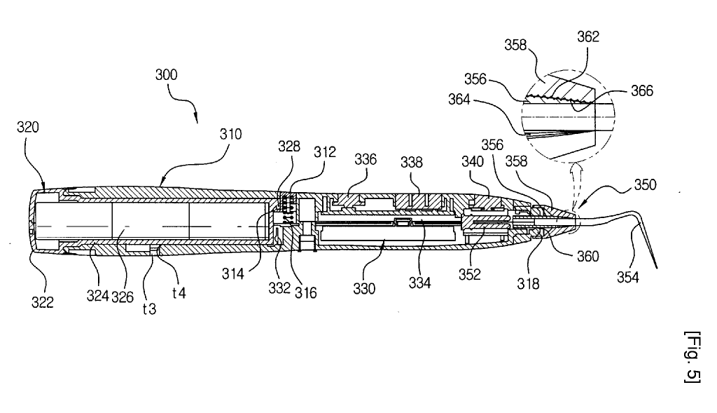

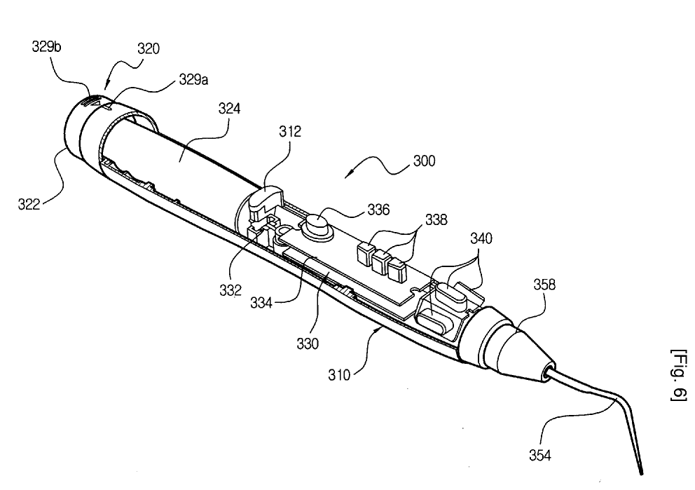

FIG. 4 is a perspective view illustrating the pen-type vertical spreader shown in FIG. 1. FIG. 5 is a sectional view taken along line A-A of FIG. 4. FIG. 6 is a perspective view illustrating the interior of the pen-type vertical spreader of FIG. 4.

The pen-type vertical spreader 300 shown in FIGS. 4 through 6 may be seated in the first charging seat 242 of the battery charger 200 when the spreader 300 is required to be charged or the spreader 300 is not being used.

The pen-type vertical spreader 300 comprises a pen-shaped body part 310; a first rechargeable battery unit 320 detachably attached to the pen-shaped body part 310; a first control unit 330 installed in the pen-shaped body part 310 and electrically connected to the first rechargeable battery unit 320; and a chucking unit 350. The chucking unit 350 locks a conventional plugger tip 354 to an end of the pen-shaped body part 310 and is electrically connected to the first control unit 330, thus thermally softening gutta-percha cones packed into a root canal.

The pen-shaped body part 310 has a conventional pen shape, which is axially hollow and is open at opposite ends thereof. Preferably, the pen-shaped body part 310 is configured such that a first end thereof has a gradually reduced diameter and, therefore, the diameter of the first end of the pen-shaped body part 310 is smaller than the diameter of the second end of the pen-shaped body part 310. A first locking switch 312 is placed in the pen-shaped body part 310 at an intermediate position of the pen-shaped body part 310 such that the switch 312 extends in a radial direction. A hook-type first locking protrusion 314 is formed at an inner end of the first locking switch 312, which radially and inwardly extends in the pen-shaped body part 310. A first spring 316 is vertically placed below the first locking switch 312, thus elastically biasing the switch 312 outwards in a radial direction.

A holding protrusion 318 is formed around the inner surface of the first end of the pen-shaped body part 310 such that the holding protrusion 318 inwardly protrudes towards the center of the body part 310. A third charging terminal t3 is provided at a predetermined position in the second end of the pen-shaped body part 310 such that the terminal t3 is exposed outside the body part 310 and comes into contact with the first charging terminal t1. The pen-shaped body part 310 is provided with the first rechargeable battery unit 320, the first control unit 330, and the chucking unit 350, as described above.

The first rechargeable battery unit 320 comprises a cylindrical first cover 322, which closes the second end of the pen-shaped body part 310. A first rechargeable battery casing 324 axially and inwardly extends from the inside end of the first cover 322 toward the interior of the pen-shaped body part 310, with a first rechargeable battery 326 installed in the first rechargeable battery casing 324. In the above state, a hook-type second locking protrusion 328 is formed at the inside end of the first rechargeable battery casing 324, which extends inwards in the pen-shaped body part 310, so that the hook-type second locking protrusion 328 engages with the first locking protrusion 314. A fourth charging terminal t4 is provided at a predetermined position around the first rechargeable battery casing 324 such that the fourth charging terminal t4 comes into close contact with the third charging terminal t3. Preferably, to cause the second locking protrusion 328 of the first rechargeable battery casing 324 to precisely engage with the first locking protrusion 314 of the first locking switch 312, a first mounting mark 329a is provided on the outer circumferential surface of the second end of the pen-shaped body part 310 at a predetermined position. Furthermore, a second mounting mark 329b having a triangular shape is provided on the outer circumferential surface of the first cover 322 at a predetermined position, so that the second mounting mark 329b can be aligned with the first mounting mark 329a when the two locking protrusions 314 and 328 have completely engaged with each other. Preferably, the first rechargeable battery 326 is selected from nickel-hydrogen batteries having a current capacity of 650 mA, a protective circuit, which comprises a poly S/W, and a voltage of 3.6V.

The first control unit 330 comprises a first power supply terminal 332, a first controller 334 and a first actuating switch 340. The first power supply terminal 332 is arranged at a predetermined position adjacent to the first rechargeable battery casing 324 such that the electricity from the first rechargeable battery 326 can be supplied to the first power supply terminal 332. In other words, the first power supply terminal 332 is placed around the inside end of the first locking switch 312. The first controller 334 is placed at a predetermined position around the first power supply terminal 332 so that electricity can be supplied from the first power supply terminal 332 to the first controller 334. A mode switch 336, for setting the size of the plugger tip 354, is provided in the pen-shaped body part 310 such that the mode switch 336 is electrically connected to the first controller 334 at an inside end thereof and is exposed outside the pen-shaped body part 310 at an outside end thereof. In the same manner, at pre-determined positions around the mode switch 336, a plurality of heating display lamps 338 for displaying a heated state of the plugger tip 354 corresponding to a preset size may be provided such that the heating display lamps 338 are electrically connected to the first controller 334 and are exposed outside the pen-shaped body part 310. The first actuating switch 340 is provided on the outer circumferential surface of the pen-shaped body part 310 at a predetermined position adjacent to the first end of the body part 310 such that the switch 340 is electrically connected to the first controller 334. In the present invention, the root canal plugger may be provided with a plurality of first actuating switches 340 at predetermined positions around the outer circumferential surface of the pen-shaped body part 310, thus allowing an endodontist to easily actuate the root canal plugger during root canal treatment.

Preferably, when an endodontist presses the mode switch 336 briefly once with a finger, the root canal plugger is set to the smallest size among the sizes of the plugger tip 354. When the mode switch 336 is pressed briefly twice with a finger, the root canal plugger is set to the intermediate size among the sizes of the plugger tip 354. In the same manner, when the mode switch 336 is pressed briefly three times with a finger, the root canal plugger is set to the largest size among the sizes of the plugger tip 354. Thus, the initial output conditions and the controlled output conditions can be appropriately set by the size of the plugger tip 354, so that it is possible to protect against an initial rapidly heated state or an overheated state of the plugger tip 354. When the mode switch 336 is pressed for a long time once, the mode switch 336 is turned off. The heating display lamp 338 is preferably selected from dual color LEDs. In the above state, the heating display lamp 338 emits green light during a general heating state and emits red light during a quick heating state.

The chucking unit 350 comprises a tip holder 352; a tip chuck 356, which is provided at an end of the tip holder 352 and into which a conventional plugger tip 354 is inserted; and a chucking nut 358, which locks the plugger tip 354 to the tip chuck 356. The tip holder 352 is provided below the inside end of the first actuating switch 340 at a position around an end of the first controller 334. The tip holder 352 is electrically connected to the first controller 334 and is operated in conjunction with the first actuating switch 340, thus applying electricity to the plugger tip 354 and causing the plugger tip 354 to generate heat due to resistance. The tip chuck 356 has a cylindrical shape, which is open at first and second ends thereof. The second end of the tip chuck 356 extends into the pen-shaped body part 310 such that the second end of the chuck 356 is placed at a predetermined position adjacent to the tip holder 352, while the first end is exposed outside the pen-shaped body part 310. In the above state, a locking groove 360 is formed around the outer circumferential surface of the tip chuck 356 at a position around the second end, so that the holding protrusion 318 of the pen-shaped body part 310 engages with the locking groove 360. The first end of the tip chuck 356 axially extends outwards while the outer diameter thereof is gradually reduced to be tapered, with an external thread 362 formed around the tapered outer circumferential surface of the tip chuck 356 and a plurality of cut slots 364 axially formed along the tapered outer circumferential surface to divide the surface into a plurality of sections. The chucking nut 358 is a hollow body through which the plugger tip 354 is fitted from a first end to a second end of the nut 358. An internal thread 366 is formed around the inner circumferential surface of the chucking nut 358, so that the chucking nut 358 can be fastened to the tip chuck 356 while compressing the tip chuck 356, with the internal thread 366 of the chucking nut 358 engaging with the external thread 362 of the tip chuck 356.

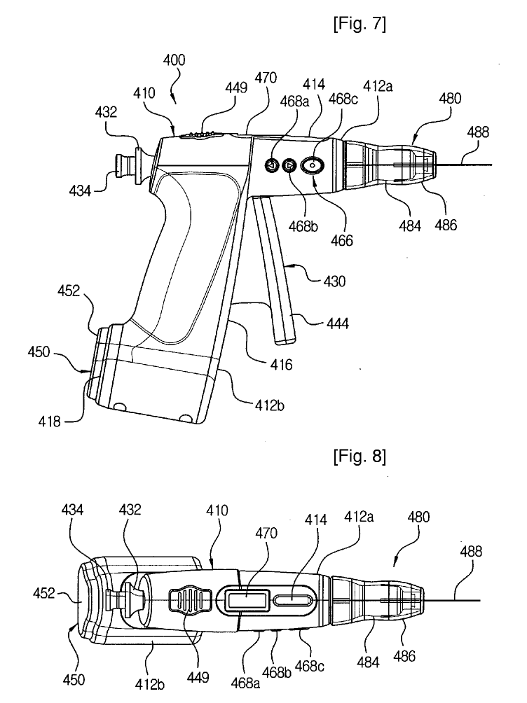

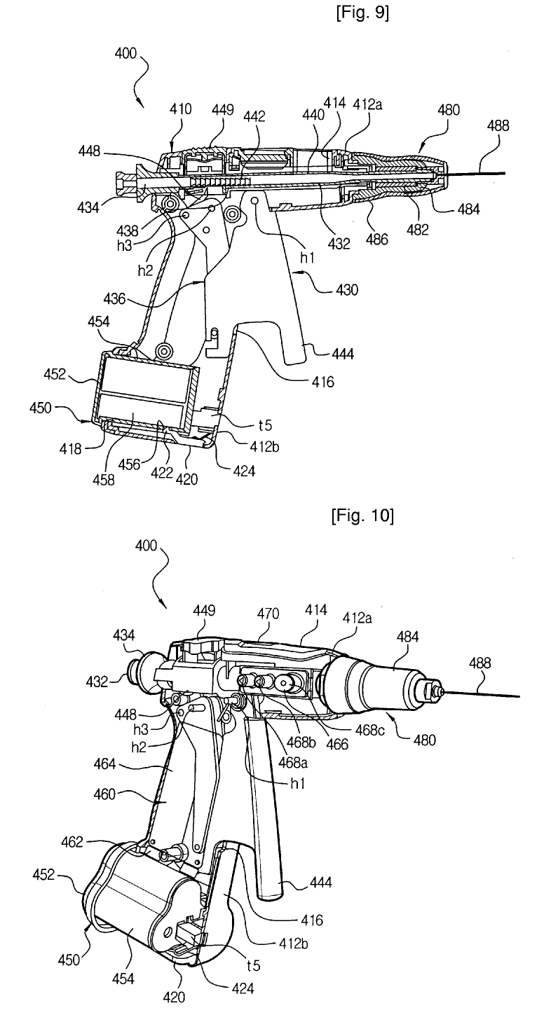

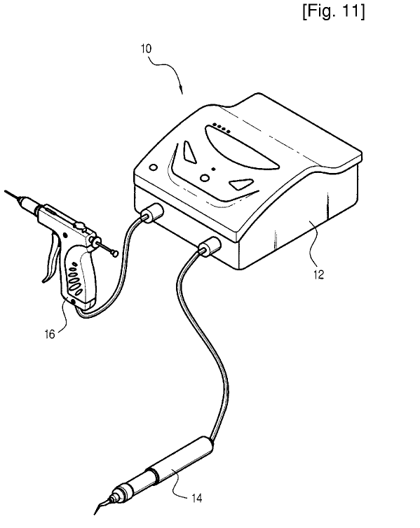

FIG. 7 is a front view illustrating the gun-type injection device shown in FIG. 1. FIG. 8 is a plane view illustrating the gun-type injection device shown in FIG. 1. FIG. 9 is a sectional view taken along line B-B of FIG. 8.

FIG. 10 is a perspective view illustrating the interior of the gun-type injection device of FIG. 7.

The gun-type injection device 400 shown in FIGS. 7 through 10 is seated in the second charging seat 244 of the battery charger 200 when it is required to be electrically charged or when it is not being used.

The gun-type injection device 400 comprises a gun-shaped body part 410 having a shape similar to the shape of a conventional gun; an actuation unit 430 provided in the gun-shaped body part 410; a second rechargeable battery unit 450 detachably attached to the gun-shaped body part 410; a second control unit 460 provided in the gun-shaped body part 410 and electrically connected to the second rechargeable battery unit 450; and a heating and discharging unit 480 electrically connected to the second control unit 460, thus thermally softening and discharging a gutta-percha bar, which has been input into the actuation unit 430 through the gun-shaped body part 410.

The gun-shaped body part 410 comprises a first chamber body 412a and a second chamber body 412b. The first chamber body 412a is a hollow cylindrical body, which is open at opposite ends thereof. A first inlet hole 414 is formed in the upper surface of the first chamber body 412 at a predetermined position around a first end of the body 412, so that conventional gutta-percha bars can be input into the first chamber body 412 through the first inlet hole 414. The second chamber body 412b extends downwards from the lower end of a second end of the first chamber body 412a. A vertical first slit 416 is formed on the surface of the second chamber body 412b, while a vertical second slit 418 is formed on the lower part of another surface of the body 412b opposite the first slit 416. A second locking switch 420 is provided in the lower surface of the second chamber body 412b. Furthermore, a third locking protrusion 422 is provided on the upper surface of a second end of the second locking switch 420 such that the third locking protrusion 422 extends upwards into the second chamber body 412b. A second spring 424 is placed on the upper surface of a first end of the second locking switch 420.

The actuation unit 430 comprises an actuating cylinder 432, a plunger 434 movably fitted into the actuating cylinder 432, and a trigger unit 436, which actuates the plunger 434 to move it forwards. The actuating cylinder 432 has a hollow cylindrical body, which extends from the second end of the first chamber body 412a to a position outside the first end of the first chamber body 412a. An opening 438 is formed in the lower surface of the actuating cylinder 432 at a predetermined position adjacent to the second end of the cylinder 432 such that the opening 438 is opened toward the second chamber body 412b. A second inlet hole 440 is formed in the upper surface of the actuating cylinder 432 at a predetermined position adjacent to the first end such that the second inlet hole 440 communicates with the first inlet hole 414. Thus, gutta-percha bars can be guided into the actuating cylinder 432. The plunger 434 extends from the second end of the actuating cylinder 432 into the interior of the actuating cylinder 432. A plurality of advancing grooves 442, each having a tapered shape, is formed around the intermediate portion of the plunger 434, so that the advancing grooves 442 can be exposed outside the opening 438. The trigger unit 436 comprises a trigger 444, which is rotatably coupled by a first hinge h1 to an upper part in the interior of the second chamber body 412b such that part of the trigger 444 is exposed outside the first slit 416; and an actuating lever 446, which is placed behind the second end of the trigger 444 and is rotatably coupled by a second hinge h2 to the interior of the second chamber body 412b at an upper end thereof and movably engages with the lower part of the second end of the trigger 444. Furthermore, an actuator 448 is rotatably coupled by a third hinge h3 to the upper end of the actuating lever 446 at a lower end thereof, so that the upper end of the actuator 448 engages with one of the advancing grooves 442, thus advancing the plunger 434 in response to operation of the trigger 444. A plunger reset switch 449 is preferably provided in the outer circumferential surface of the actuating cylinder 432 having the opening 438 such that the plunger reset switch 449 extends downwards from the upper surface of the first chamber body 412a. The plunger reset switch 449 can remove the actuator 448 from the advancing grooves 442 and, therefore, the plunger 434 can be retracted. In the gun-shaped body part 410 having the above-mentioned actuation unit 430, the second rechargeable battery unit 450, the second control unit 460, and the heating and discharging unit 480 are installed.

The second rechargeable battery unit 450 comprises a second cover 452, which closes the second slit 418 of the second chamber body 412b; and a second rechargeable battery casing 454, which extends horizontally from the second cover 452 into the second chamber body 412b and receives a second rechargeable battery 458 therein. A locking hole 456 is formed in the lower surface of the second rechargeable battery casing 454 such that the third locking protrusion 422 can be locked into the locking hole 456. A fifth charging terminal t5 is provided on the surface of the second rechargeable battery casing 454 such that the terminal t5 is exposed outside the surface of the second chamber body 412b and can come into contact with the second charging terminal t2 of the battery charger 200. Preferably, the second rechargeable battery 458 is selected from nickel-hydrogen batteries having a current capacity of 2,000 mA, a protective circuit, which comprises a poly S/W, and a voltage of 3.6V.

The second control unit 460 comprises a second power supply terminal 462, a second controller 464 and a second actuating switch 466. The second power supply terminal 462 is placed at a predetermined position around the second rechargeable battery casing 454, so that electricity from the second rechargeable battery 458 can be supplied to the second power supply terminal 462. The second controller 464 is placed above the second power supply terminal 462, so that electricity from the second power supply terminal 462 can be supplied to the second controller 464. In the above state, the second controller 464 is installed inside the second chamber body 412b such that the controller 464 does not interfere with the motion of the trigger 444 or of the actuating lever 446. The second actuating switch 466 is placed inside the first chamber body 412a such that the switch 466 does not interfere with the actuating cylinder 432. The second actuating switch 466 comprises a temperature-up switch 468a, a temperature-down switch 468b and a power switch 468c. A temperature display window 470 is provided on the upper surface of the first chamber body 412a such that the display window 470 is exposed outside the body 412a and is electrically connected both to the second controller 464 and to the second actuating switch 466.

The heating and discharging unit 480 comprises a heater 482, which is mounted to the first end of the first chamber body 412a and thermally softens the gutta-percha bars, with a conventional needle 488 mounted to an end of the heater 482 so as to discharge the softened gutta-percha into the root canal. The heater 482 surrounds the outer circumferential surface of the actuating cylinder 432, which is exposed outside the first chamber body 412a. The heater 482 is also electrically connected both to the second controller 464 and to the second actuating switch 466, and, therefore, gutta-percha bars injected by the plunger 434 can be thermally softened. A heater cap 484 is fastened to the outer circumferential surface of the heater 482 such that the heater cap 484 engages with the first end of the first chamber body 412a. Preferably, a heater insulator cap 486 is fitted over the heater cap 484, thus preventing heat of the heater 482 from being transferred to the atmosphere.

Herein below, the operation of the cordless complex root canal plugger 100 for dental clinics according to the present invention will be described.

First, to electrically charge both the pen-type vertical spreader 300 and the gun-type injection device 400, the battery charger 200 is turned on, and the pen-type vertical spreader 300 and the gun-type injection device 400 are respectively seated in the first charging seat 242 and the second charging seat 244, which are formed in the upper casing 240 of the battery charger 200. In the above state, the trigger 444 of the gun-type injection device 400 is seated in the third charging seat 254. The pen-type vertical spreader 300 and the gun-type injection device 400 are respectively inserted into the first locking hook 232 of the first charging seat 242 and the second locking hook 234 of the second charging seat 244, and are respectively held by the first grip pads 262 and the second grip pads 264. The third charging terminal t3 of the pen-type vertical spreader 300 comes into contact with the first charging terminal t1, while the fifth charging terminal t5 of the gun-type injection device 400 comes into contact with the second charging terminal t2. Thus, the third charging terminal t3, which is in contact with the first charging terminal t1, is also brought into contact with the fourth charging terminal t4, so that the first rechargeable battery 326 can be charged with electricity. In the same manner, because the fifth charging terminal t5 is in contact with the second charging terminal t2, the second rechargeable battery 458 can be charged with electricity. When the first rechargeable battery 326 and the second rechargeable battery 458 have been completely charged with electricity, the first display lamp 256 and the second display lamp 258 of the battery charger 200 emit light to inform an endodontist of the charged states of the pen-type vertical spreader 300 and the gun-type injection device 400. Preferably, the first display lamp 256 informs the endodontist of the charged state of the pen-type vertical spreader 300, while the second display lamp 258 informs the endodontist of the charged state of the gun-type injection device 400.

When the pen-type vertical spreader 300 and the gun-type injection device 400 have been completely charged with electricity as described above, the endodontist drills and reams a decayed tooth using drilling and reaming implements, thus removing a decayed part of the tooth. Thereafter, the endodontist inserts a plurality of conventional gutta-percha cones (not shown), having a size corresponding to the size of the dental implements used, into the root canal of the tooth. When the gutta-percha cones have been completely inserted into the root canal of the tooth, the endodontist attaches an appropriate plugger tip 354 to the completely charged pen-type vertical spreader 300. Thereafter, the size of the plugger tip 354 is preset using the mode switch 336, and the first actuating switch 340 is manipulated with a finger under the condition that the plugger tip 354 is brought into close contact with the gutta-percha cones in the root canal. When the first actuating switch 340 is manipulated by the endodontist as described above, the first controller 334 of the first control unit 330 supplies electricity to the tip holder 352 having the plugger tip 354. The electrically activated plugger tip 354 generates heat due to resistance and, therefore, the gutta-percha cones in the root canal are thermally softened by the heated plugger tip 354 and are packed into the root canal. When the gutta-percha cones have been completely softened and packed into the root canal, the pen-type vertical spreader 300 is seated in the first charging seat 242 of the battery charger 200.

If a cavity remains in the root canal irrespective of execution of the plugging procedure using both the gutta-percha cones and the pen-type vertical spreader 300, the cavity is preferably plugged with gutta-percha bars using the gun-type injection device 400. To execute a root canal plugging procedure using the gun-type injection device 400, a plurality of conventional gutta-percha bars (not shown) having a bar-shaped configuration is installed in the gun-type injection device 400. To install the gutta-percha bars in the gun-type injection device 400, the plunger reset switch 449 is manipulated to retract the plunger 434 rearwards and, thereafter, the gutta-percha bars are input into the first inlet hole 414. The gutta-percha bars input in the first inlet hole 414 are guided into the actuating cylinder 432 through the second inlet hole 440. When the gutta-percha bars have been completely installed in the actuating cylinder 432 as described above, the endodontist manipulates the power switch 468c of the second actuating switch 466, thus electrically turning on the heater 482. Furthermore, the endodontist pushes the plunger 434 towards the heater 482. In the above state, the heater 482 thermally softens the gutta-percha bars, while one of the advancing grooves 442, which are formed around the plunger 434, is exposed through the opening 438 and is caught by the actuator 448 passing through the opening 438. In the above state, the endodontist places the needle 488 at a position adjacent to the decayed tooth and slowly manipulates the trigger 444, so that the actuating lever 446 is rotated. Due to the rotation of the actuating lever 446, the actuator 448 is operated and moves the plunger 434 forwards. Thus, the gutta-percha, which has been thermally softened by the heater 482, is discharged from the needle 488 into the remaining cavity of the tooth due to the forward movement of the plunger 434, so that the remaining cavity can be plugged with the gutta-percha.

### INDUSTRIAL APPLICABILITY

As described above, the cordless complex root canal plugger 100 for dental clinics according to the present invention comprises a battery charger 200, a cordless pen-type vertical spreader 300, and a cordless gun-type injection device 400, which are provided as a group of complementary products and in which the pen-type vertical spreader 300 and the gun-type injection device 400 have respective rechargeable batteries 326 and 458 and respective controllers 334 and 464. Thus, the cordless complex root canal plugger for dental clinics allows an endodontist to move freely in a dental clinic while executing a root canal plugging procedure using the cordless complex root canal plugger during nerve treatment and, therefore, the endodontist can more easily, rapidly and precisely pack a root canal with a filler material.

Furthermore, in the cordless complex root canal plugger according to the present invention, the pen-type vertical spreader 300 and the gun-type injection device 400 do not require separate controller boxes, unlike a conventional root canal plugger. Thus, the cordless complex root canal plugger can be efficiently used in a dental clinic having a limited space and is free from a problem of tangled electric cords, unlike the conventional root canal plugger having electric cords, so that patients can feel pleasant and comfortable. Unlike the conventional root canal plugger 10, in which a lot of electricity is lost from both the electric cords and the electric connectors, the pen-type vertical spreader 300 and the gun-type injection device 400 according to the present invention do not lose electricity from electric cords or electric connectors, so that the cordless complex root canal plugger of the present invention can be efficiently used with a small electric current.

1. A cordless complex root canal plugger for dental clinics, comprising: a battery charger comprising: a lower casing provided with both a first charging terminal and a second charging terminal therein; and an upper casing, which covers the lower casing and is provided with a first charging seat and a second charging seat, through which the first charging terminal and the second charging terminal of the lower casing are exposed outside the battery charger, respectively; a pen-type vertical spreader comprising: a pen-shaped body part; a first rechargeable battery unit detachably attached to the pen-shaped body part and brought into contact with the first charging terminal to be charged with electricity; a first control unit placed in the pen-shaped body part and electrically connected to the first rechargeable battery unit; and a chucking unit, which locks a plugger tip to an end of the pen-shaped body part and is electrically connected to the first control unit, thus generating heat due to resistance and thermally softening a gutta-percha cone packed into a root canal, wherein the pen-type vertical spreader is seated in the first charging seat of the battery charger when the pen-type vertical spreader is required to be charged with electricity or when the spreader is not being used; and a gun-type injection device comprising: a gun-shaped body part having a shape similar to the shape of a conventional gun; an actuation unit provided in the gun-shaped body part; a second rechargeable battery unit detachably attached to the gun-shaped body part and brought into contact with the second charging terminal to be charged with electricity; a second control unit provided in the gun-shaped body part and electrically connected to the second rechargeable battery unit; and a heating and discharging unit electrically connected to the second control unit, thus thermally softening and discharging a gutta-percha bar, which has been input into the actuation unit through the gun-shaped body part, wherein the gun-type injection device is seated in the second charging seat of the battery charger when the gun-type injection device is required to be charged with electricity or when the injection device is not being used, wherein the battery charger, the pen-type vertical spreader and the gun-type injection device are provided as a group of complementary products.

2. The cordless complex root canal plugger for dental clinics according to claim 1, wherein the lower casing comprises: a flat bottom plate stably placed on a support surface; a first side plate and a second side plate integrally formed at opposite ends of the flat bottom plate such that the first and second side plates face each other, each of the first and second side plates being curved along an upper edge thereof such that a radius of curvature of a first side of the curved upper edge is longer than a radius of curvature of a second side; a power converter unit provided on the bottom plate to convert a direction of an input electric current; a charging unit placed around the power converter unit, with the first and second charging terminals provided on the charging unit at positions adjacent to the first and second side plates, respectively; a first locking hook having a U-shape placed at a position adjacent to the first charging terminal; and a second locking hook having a U-shape placed at a position adjacent to the second charging terminal.

3. The cordless complex root canal plugger for dental clinics according to claim 2, wherein the first locking hook and the second locking hook are respectively provided at upper ends thereof with first grip pads and second grip pads made of rubber such that the first grip pads and the second grip pads face each other.

4. The cordless complex root canal plugger for dental clinics according to claim 2, wherein the upper casing has a curved shape so as to correspond to the curved shape of the first and second side plates, with a radius of curvature of a first surface of the curved upper casing being longer than a radius of curvature of a second surface, the upper casing comprising: the first and second charging seats formed in the first surface having the longer radius of curvature at positions adjacent to the first and second side plates, respectively, such that a bottom surface of the first charging seat is curved downwards and the second charging seat is vertically depressed downwards; first and second terminal holes respectively provided in the first and second charging seats to expose the first and second charging terminals outside the first and second charging seats; and first and second exposure holes respectively formed in the first and second charging seats to expose the first and second locking hooks outside the first and second charging seats.

5. The cordless complex root canal plugger for dental clinics according to claim 1, wherein a third charging seat, having a width smaller than a width of the second charging seat, is formed in the upper casing by being depressed downwards at a position adjacent to a surface of the second charging seat.

6. The cordless complex root canal plugger for dental clinics according to claim 1, wherein the charging unit comprises: a first display lamp and a second display lamp, which display the charged states of the pen-type vertical spreader and the gun-type injection device, respectively; and a power lamp placed between the first and second display lamps to inform a user of the on/off state of the battery charger, wherein the lamps are exposed outside the upper casing at positions between the first and second charging seats.

7. The cordless complex root canal plugger for dental clinics according to claim 1, wherein the pen-shaped body part of the pen-type vertical spreader has a conventional pen shape, which is hollow and is open at opposite ends thereof, the pen-shaped body part comprising: a first locking switch provided at an intermediate position of the pen-shaped body part such that the first locking switch extends inwards in a radial direction; a hook-type first locking protrusion formed at an inner end of the first locking switch; a first spring vertically placed below the first locking switch; a holding protrusion formed around an inner surface of a first end of the pen-shaped body part such that the holding protrusion inwardly protrudes towards a center of the pen-shaped body part; and a third charging terminal provided at a predetermined position in a second end of the pen-shaped body part such that the third charging terminal is exposed outside the pen-shaped body part to come into contact with the first charging terminal.

8. The cordless complex root canal plugger for dental clinics according to claim 7, wherein the rechargeable battery unit of the pen-type vertical spreader comprises: a first cover, which closes an end of the pen-shaped body part; a first rechargeable battery casing inwardly extending from the first cover into the pen-shaped body part, with a first rechargeable battery installed in the first rechargeable battery casing; a hook-type second locking protrusion provided at an end of the first rechargeable battery casing to engage with the first locking protrusion; and a fourth charging terminal provided at a predetermined position around the first rechargeable battery casing to come into close contact with the third charging terminal.

9. The cordless complex root canal plugger for dental clinics according to claim 8, wherein, to cause the second locking protrusion to precisely engage with the first locking protrusion, a first mounting mark is provided on an outer surface of the pen-shaped body part at a predetermined position, and a second mounting mark having a triangular shape is provided on an outer surface of the first cover at a predetermined position to be aligned with the first mounting mark.

10. The cordless complex root canal plugger for dental clinics according to claim 8, wherein the control unit of the pen-type vertical spreader comprises: a first power supply terminal arranged at a predetermined position adjacent to the first rechargeable battery casing such that electricity of the first rechargeable battery is supplied to the first power supply terminal; a first controller placed at a predetermined position around the first power supply terminal such that electricity of the first power supply terminal is supplied to the first controller, with a mode switch provided in the first controller to be exposed outside the pen-shaped body part and to correspond to a size of the plugger tip; a first actuating switch provided on the outer surface of the pen-shaped body part at a predetermined position such that the first actuating switch is electrically connected to the first controller; and a plurality of heating display lamps provided at predetermined positions around the mode switch such that the heating display lamps are electrically connected to the first controller and are exposed outside the pen-shaped body part, and display a heated state of the plugger tip corresponding to a preset size.

11. The cordless complex root canal plugger for dental clinics according to claim 10, wherein the chucking unit comprises: a tip holder provided at a position around an end of the first controller and electrically connected to the first controller, and operated in conjunction with the first actuating switch, thus applying electricity to the plugger tip and causing the plugger tip to generate heat; a tip chuck having a cylindrical shape having first and second open ends such that the second end of the tip chuck extends into the pen-shaped body part to be placed at a predetermined position adjacent to the tip holder, while the first end is exposed outside the pen-shaped body part; and a chucking nut having a hollow shape through which the plugger tip is fitted from a first end to a second end of the chucking nut, so that the chucking nut locks the plugger tip to the tip chuck while compressing the tip chuck, wherein a first end of the tip chuck axially extends outwards while an outer diameter thereof is gradually reduced to be tapered, with an external thread formed around the tapered outer surface of the tip chuck and a plurality of cut slots axially formed along the tapered outer surface to divide the surface into a plurality of sections, and an internal thread formed around an inner surface of the chucking nut so that the internal thread engages with the external thread of the tip chuck when the chucking nut is fastened to the tip chuck and compresses the tip chuck.

12. The cordless complex root canal plugger for dental clinics according to claim 1, wherein the gun-shaped body part of the gun-type injection device comprises: a first chamber body comprising a hollow cylindrical body having open opposite ends, with a first inlet hole formed in an upper surface of the first chamber body, so that gutta-percha bars are input into the first chamber body through the first inlet hole; and a second chamber body extending downwards from a lower end of the first chamber body, with a vertical first slit formed on a surface of the second chamber body, a vertical second slit formed on a lower part of another surface of the second chamber body opposite the first slit, a second locking switch provided in a lower surface of the second chamber body, a third locking protrusion provided on an upper surface of the second locking switch to extend upwards into the second chamber body, and a second spring placed on the upper surface of the second locking switch.

13. The cordless complex root canal plugger for dental clinics according to claim 12, wherein the actuation unit comprises: an actuating cylinder having a hollow cylindrical body, which extends from a second end of the first chamber body to a position outside a first end of the first chamber body, with an opening formed in a lower surface of the actuating cylinder to be open toward the second chamber body at a position adjacent to the actuating cylinder, a second inlet hole formed in an upper surface of the actuating cylinder at a predetermined position such that the second inlet hole communicates with the first inlet hole and, therefore, the gutta-percha bars can be guided into the actuating cylinder; a plunger extending into the actuating cylinder, with a plurality of advancing grooves formed around an intermediate portion of the plunger, so that the advancing grooves can be exposed outside the opening; and a trigger unit comprising a trigger rotatably coupled by a first hinge to an upper part of the second chamber body such that part of the trigger is exposed outside the first slit, an actuating lever placed behind the trigger and rotatably coupled by a second hinge to the interior of the second chamber body at an upper end thereof and movably engaging with a lower part of the trigger, and an actuator rotatably coupled by a third hinge to the upper end of the actuating lever at a lower end thereof so that the upper end of the actuator can engage with one of the advancing grooves, thus advancing the plunger forwards in response to operation of the trigger.

14. The cordless complex root canal plugger for dental clinics according to claim 13, wherein a plunger reset switch is provided in the outer surface of the actuating cylinder having the opening such that the plunger reset switch extends downwards from the upper surface of the first chamber body, and can remove the actuator from the advancing grooves, thus allowing the plunger to be retracted.

15. The cordless complex root canal plugger for dental clinics according to claim 12, wherein the rechargeable battery unit of the gun-type injection device comprises: a second cover, which closes the second slit of the second chamber body; and a second rechargeable battery casing, which extends horizontally from the second cover into the second chamber body and receives a second rechargeable battery therein, with a locking hole formed in a lower surface of the second rechargeable battery casing so that the third locking protrusion is locked into the locking hole, and a fifth charging terminal provided on a surface of the second rechargeable battery casing such that the fifth charging terminal is exposed outside a surface of the second chamber body and comes into contact with the second charging terminal.

16. The cordless complex root canal plugger for dental clinics according to claim 15, wherein the control unit of the gun-type injection device comprises: a second power supply terminal placed at a position around the second rechargeable battery casing so as to receive electricity from the second rechargeable battery; a second controller placed around the second power supply terminal so as to receive electricity from the second power supply terminal; and a second actuating switch comprising a temperature-up switch, a temperature-down switch and a power switch, placed inside the first chamber body and electrically connected to the second controller.

17. The cordless complex root canal plugger for dental clinics according to claim 16, wherein a temperature display window is provided on the upper surface of the first chamber body such that the temperature display window is exposed outside the first chamber body and is electrically connected both to the second controller and to the second actuating switch.

18. The cordless complex root canal plugger for dental clinics according to claim 12, wherein the heating and discharging unit comprises: a heater mounted to an end of the first chamber body such that the heater surrounds an outer surface of the actuating cylinder exposed outside the first chamber body and is electrically connected both to the second controller and to the second actuating switch, thus thermally softening the gutta-percha bars, with a needle mounted to an end of the heater so as to discharge the softened gutta-percha into the root canal; and a heater cap fastened to the outer surface of the heater by engaging with the end of the first chamber body.

19. The cordless complex root canal plugger for dental clinics according to claim 18, wherein the heating and discharging unit further comprises: a heater insulator cap fitted over the heater cap, thus preventing heat of the heater from being transferred outside the heater cap.
